(19) United States
(12) Patent Application Publication
(10) Pub. No.: US 2025/0299089 A1
(43) Pub. Date: Sep. 25, 2025

(54) AUTOMATICALLY GENERATING DOCUMENTS WITH MODEL ELEMENT PROPERTIES

(71) Applicant: SAP SE, Walldorf (DE)

(72) Inventors: Rashmi Acharya, Bangalore (IN); Prathibha Vadugu, Bangalore (IN)

(21) Appl. No.: 18/609,933

(22) Filed: Mar. 19, 2024

(51) Int. Cl. G06N 20/00

(52) U.S. Cl. CPC G06N 20/00

(57) ABSTRACT

Complex data models integrate information from diverse sources in data modeling server. The parser and integrator service in data modeling server accesses metadata describing data model and uses template for creating a document. Based on the template and the metadata, the parser and integrator service automatically generate a document that shows element properties of data models. This document serves as an abstract representation, visually illustrating the properties of elements within data models. The system facilitates interactive user input, enabling users to input prompts directed to a generative AI component. This AI processes the prompts, generating results seamlessly integrated into the automatically generated document. In essence, this scenario encapsulates a sophisticated approach to data modeling, where automated processes, guided by metadata and templates, generate insightful documents representing the properties of complex data models. User interaction with generative AI adds a dynamic layer to the process, enhancing the document with tailored insights.

### TECHNICAL FIELD

The subject matter disclosed herein generally relates to automatic generation of unified documents with element properties of data models underlying data models.

### BACKGROUND

A data modeling application (e.g., provided as software as a service [SaaS]) accesses data from multiple sources, such as relational databases, data warehouses, data lakes, application output, unstructured data, and semi-structured data. Using the accessed data, the data modeling application generates data models that are used as inputs to other applications.

Information about the specific element properties of data model to the generated output is available within the data modeling application, but is not available to the applications accessing the data model.

### BRIEF DESCRIPTION OF THE DRAWINGS

FIG. 1 shows a network diagram illustrating an example network environment suitable for automatically generating a document having element properties of a data model.

FIG. 2 shows a block diagram of a data modeling server, suitable for automatically generating a document having element properties of a data model, according to some example embodiments.

FIG. 3 shows an illustration of a data source in the form of a file, according to some example embodiments.

FIG. 4 shows an illustration of a database schema, suitable for use as a database data source, according to some example embodiments.

FIG. 5 shows an illustration of data views that combine data from the file data source of FIG. 3 and the database data source of FIG. 4, according to some example embodiments.

FIG. 6 shows an illustration of a dependency graph that shows relationships between data sources and a data model, according to some example embodiments.

FIG. 7 shows an illustration of a data model of a data modeling server, according to some example embodiments.

FIG. 8 shows a flowchart illustrating operations of an example method suitable for replicating a data model based on a unified document having element properties of a data model, according to some example embodiments.

FIG. 9 shows a flowchart illustrating operations of an example method suitable for automatically generating a document having element properties of a data model.

FIGS. 10-11 show example portions of a file containing a JSON (JavaScript Object Notation) object suitable for automatically generating a document having element properties of a data model.

FIGS. 12-13 show an example of a template for automatically generating a document having element properties of a data model.

FIGS. 14-17 show an example of an automatically generated document having element properties of a data model.

FIG. 18 shows an illustration of a user interface for generating a document having element properties of a data model, according to some example embodiments.

FIG. 19 shows a block diagram showing one example of a software architecture for a computing device.

FIG. 20 shows a block diagram of a machine in the example form of a computer system within which instructions may be executed for causing the machine to perform any one or more of the methodologies discussed herein.

### DETAILED DESCRIPTION

Example methods and systems are directed to a data modeling system that exports a unified document with element properties of a data model. Complex data models combine data from multiple data sources and enhance the data. When such data models are shared with other applications that consume the data models, a user of the consuming application may make incorrect assumptions about the meaning of the data, resulting in erroneous conclusions. By automatically generating a document that shows the element properties of the data model, additional information about the model is provided to the user of the consuming application, improving the user's ability to properly use the data model.

Among the details that may be included in the document are data filters, filter expressions, types of aggregations of measures, restrictions on measures, and the like. A data filter removes, or “filters out,” a portion of the input data. For example, a data table with monthly sales data for the last twenty years may be filtered so that only information from the last five years is included in the model. The filter expression for a filter defines how the data is filtered.

Aggregations combine multiple input data points into a single output data point. For example, an aggregation may be performed on the monthly sales data to generate annual sales data by adding the monthly values. As other examples, daily temperature data may be aggregated to generate average, minimum, or maximum monthly temperature data by averaging the daily values for each month, taking the minimum temperature in each month, or taking the maximum temperature in each month.

Calculated measures are calculations based on other, already existing measures-like source measures, restricted measures, or other calculated measures. This means that these other measures are calculated first and then the calculation is performed. This order is important because it largely affects the overall result.

Restricted measures build on existing measures, but run flexible filters on them. For example, data for the “Revenue of France” may be selected from a global data table by adding a filter for “country=‘France’.” A restricted measure variable can be a single value, multiple values, an interval or a range of values.

As described herein, a parser and integrator service that is used to generate a unified document for complex data models. With a click of a button, users can generate a unified document that consolidates and organizes intricate information from complex data models. The generated unified document can easily be shared. This sharing capability enhances collaboration, facilitates communication, and ensures a clear and common understanding of the complex data models. This will reduce the time and resources spent on understanding the data models.

Metadata extraction or parsing involves systematically retrieving and capturing information about the underlying data model from the modeling system. This enables a comprehensive understanding of the structure, relationships, and attributes of the data, enabling effective data analysis and representation. The parser extracts metadata from the model, capturing information about entities, relationships, and attributes. Metadata refers to data about data. In this context, metadata includes information such as data types, formats, source locations, creation dates, and other attributes that describe the properties of the data models. The extraction process involves using tools or algorithms to automatically scan and analyze the content of the JSON (JavaScript Object Notation) file of the data model. The extracted metadata captures information about entities, relationships, and attributes present in the data model.

Entities represent source objects or tables, relationships indicate how entities are related, and attributes define the properties of entities. The extracted metadata serves as the foundation for understanding of the data model.

The process of creating a structured representation with JSON data, uses a parser and integrator service to efficiently parse the raw data and transform it into a well-organized and structured format. The parser and integrator service is a specialized service designed to handle the parsing and integration of data. Parsing involves breaking down raw metadata from a JSON file (or other data file) into its individual component information. Integration involves combining the component information into a cohesive structure.

Structured data is data that fits neatly into data tables and includes discrete data types such as numbers, short text, and dates. Unstructured data doesn't fit neatly into a data table because of its size or nature (e.g., audio and video files and large text documents). JSON is an example of semi-structured data; JSON resources follow a standard and are substantially easier to process algorithmically than unstructured data, but efficiencies may be gained by converting the semi-structured data to structured data before further processing.

The parser service interprets and breaks down the hierarchical structure of JSON data. This involves identifying key-value pairs, arrays, and nested structures within the JSON metadata file. During the parsing process, the service establishes a clear hierarchy of data elements. This hierarchy helps in understanding the relationships and dependencies between different elements of the data model. For example, it ensures that nested elements and arrays are properly identified and structured. Raw data in its original form may contain ambiguities or inconsistencies. The parsing process helps eliminate these ambiguities by enforcing a standardized structure.

A documentation template is used to represent structured format data in a systematic and organized manner. This involves implementing distinct sections in the final unified document. The template serves as a standardized way to document different aspects of the data, ensuring clarity, comprehensiveness, and ease of understanding. The use of a parser and integrator service facilitates this documentation process. Before documentation, the metadata was parsed to transform it into a well-organized and structured format. This ensures that the data is prepared for documentation in a way that is logical, consistent, and meaningful.

The documentation template is a predefined structure that outlines the format and content of the documentation. The template is designed to capture specific information about the data, making it easier for users to navigate and understand.

The documentation is organized into distinct sections, each dedicated to a specific aspect of the data. Some examples of these could include:
Summary: An overview of the data model, its purpose, and key characteristics.
Measures: Documentation of quantitative metrics or performance indicators.
Dimensions: Descriptions of categorical columns or factors that categorize the data.
Filters: Criteria used to subset or filter the data.
Calculated Measures: Formulas or calculations applied to derive new measures.

The use of the documentation template ensures a well-organized document outcome. Information is presented in a structured manner, making it easier for users to locate specific details without unnecessary complexity.

A generative artificial intelligence (“GenAI” or “generative AI”) may be integrated into the document creation workflow. The integration of the GenAI service into the workflow adds a layer of intelligence to the content by allowing the generation of coherent and contextually relevant information. This integration aims to enhance the documentation process by creation of summaries, insights, and other narrative content based on the structured metadata extracted from JSON files and data from data model.

A user interface may be presented that includes an input field designed to accept prompts in natural language form, from the user. The prompt is provided to the GenAI, which generates a responsive output providing insights from complex models, describe patterns and trends within the data. The generated content is tailored to the specific dataset and the requirements of the documentation, ensuring that it adds value and clarity. The natural language content generated by GenAI enhances the understandability of the data model. It translates technical details and complex relationships into language that is accessible even to non-technical stakeholders.

The output data from the GenAI service may be merged with the structured data extracted from the JSON file. By merging GenAI-generated content and structured data, the unified documentation gains depth and richness. The resulted final document flows logically and is easily understandable by users, regardless of their level of technical expertise. This document not only captures the structured details of the data models but also incorporates human-like narratives, summaries, and interpretations, offering a holistic view of the information about data models.

The final phase of the process is offering users the capability to export the unified document ensuring its widespread accessibility. Users may be presented with a range of export options, ensuring flexibility in choosing the most suitable format for their specific needs. Example document formats include PDF (portable document format), HTML (hypertext markup language), or other commonly used documentation formats. By offering multiple export formats, the unified document becomes accessible across different platforms and environments.

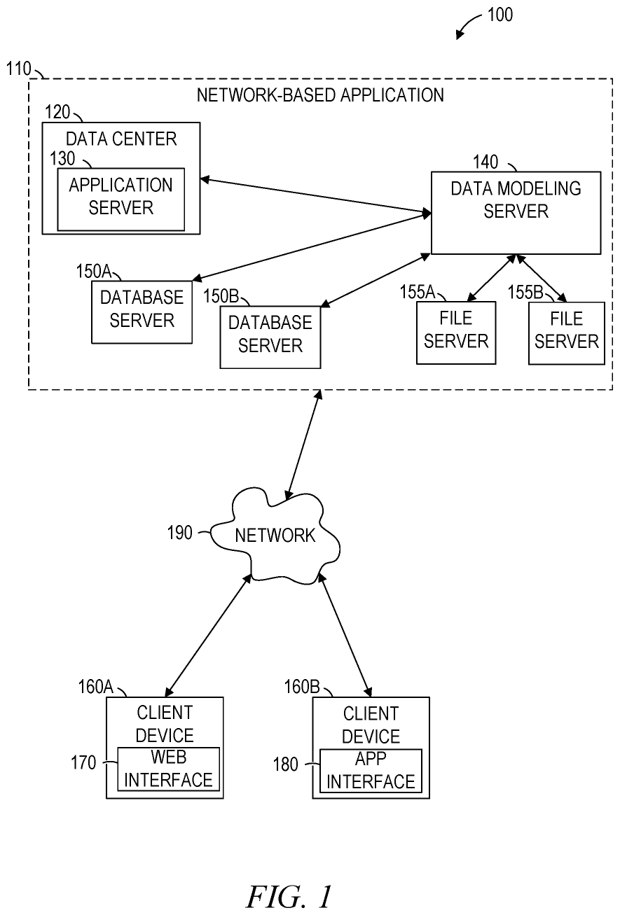

FIG. 1 shows a network diagram illustrating an example network environment suitable for automatically generating a document having element properties of a data model. The network environment 100 includes the network-based application 110, client devices 160A and 160B, and a network 190. The network-based application 110 is implemented at a data center 120 comprising an application server 130, in communication with a data modeling server 140. The data modeling server 140 gathers data from the database servers 150A and 150B and the file servers 155A and 155B. The data modeling server 140, the file servers 155A-155B, the database servers 150A-150B, or any suitable combination thereof, may be part of the data center 120.

An application executing on the application server 130 accesses data from the data modeling server 140. The data modeling server 140 accesses and processes data from the database servers 150A-150B and the file servers 155A-155B. Data from multiple servers may be combined into a single view that is accessed by the application as a database table. Data from files may be processed so that it can be accessed using a database interface. Data may be aggregated or otherwise transformed before it is made available to the application.

Using the requested data, the application running on the application server 130 provides services to the client devices 160A and 160B. For example, a user of the client device 160A may be an employee of a business using a business application. The requested data may include information about invoices, accounts payable, and the like. Using the requested data, a business report may be generated by the application and presented on a display device of the client device 160A. The user interface for the application may be presented using a web interface 170 or an app interface 180.

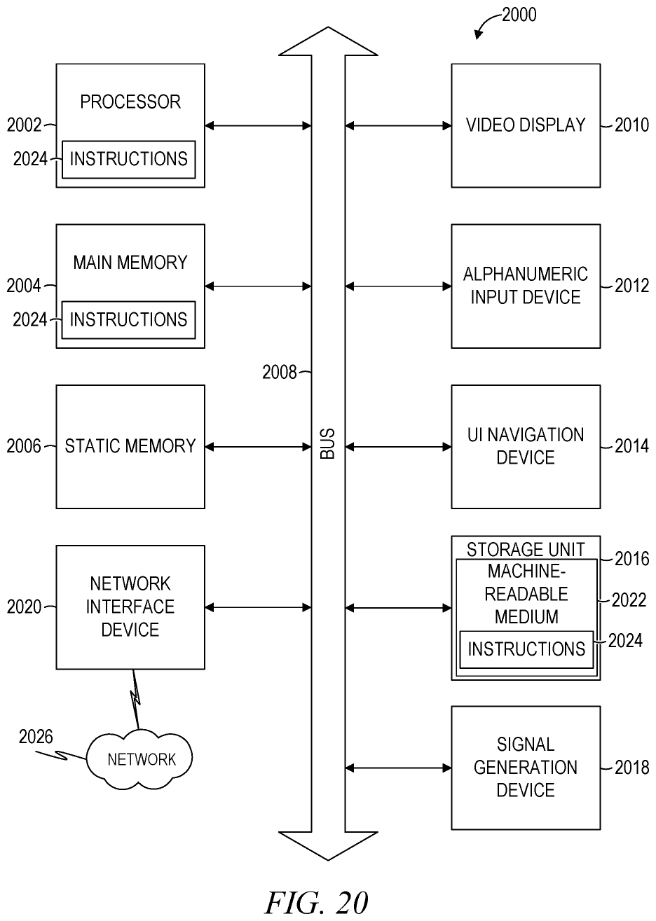

The application server 130, the data modeling server 140, the file servers 155A-155B, the database servers 150A-150B, and the client devices 160A-160B may each be implemented in a computer system, in whole or in part, as described below with respect to FIG. 20. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 20. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 130, the data modeling server 140, the file servers 155A-155B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one application server 130, two client devices 160A and 160B, and the like), any number of each element is contemplated. For example, the application server 130 may be one of dozens or hundreds of active and standby servers and provide services to millions of client devices. Likewise, the data modeling server 140 may store data used by many application servers 130, and so on.

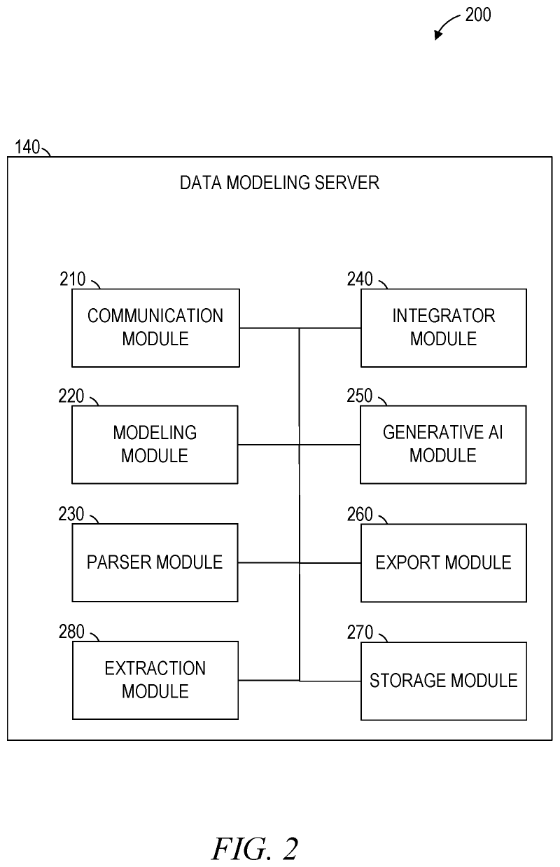

FIG. 2 shows a block diagram of the data modeling server 140 of FIG. 1, suitable for automatically generating a document with element properties of data models, according to some example embodiments. The data modeling server 140 is shown as including a communication module 210, a modeling module 220, a parser module 230, an integrator module 240, a GenAI module 250, an export module 260, a storage module 270, and an extraction module 280, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the data modeling server 140 and transmits data from the data modeling server 140. For example, the communication module 210 may receive, from the application server 130, a request for data from the modeling module 220. The requested data may be accessed using the storage module 270 and provided to the application server by the communication module 210.

The modeling module 220 takes data received from data sources, such as database tables and files, and pre-processes it into a form that is more suitable for use by applications. For example, data may be aggregated, filtered, combined, or processed by functions before being made available for use by applications.

A user of the data provided by the modeling module 220 may not be aware of the relationship between the data accessed by the data modeling server 140 and the data provided by the data modeling server 140. The parser module 230, the integrator module 240, the GenAI module 250, and the export module 260 may work together to automatically generate unified documents with element properties of data models underlying data models.

The parser module 230 parses metadata for a model to generate a structured representation of the model. For example, metadata for a model may describe, in a machine-readable format such as JSON, the manner in which input data is used to generate the model. The parser module 230 parses the metadata to extract certain details that will be included in the automatically generated document with element properties of data models.

The GenAI module 250 may also parse the metadata to generate a human-readable summary. For example, a machine-learning model may be trained to produce model summaries based on JSON files. When the trained ML model is provided a JSON file defining a model, it generates a description as an output. Additional output may be generated by the GenAI module 250 based on user-provided input. For example, a user may request insights for a particular model using a user interface. The user interface may allow the user to provide one or more questions or prompts for the GenAI module 250. After processing the metadata for the model, the GenAI module 250 is provided the one or more questions or prompts and, in response, generates insights or suggestions.

The integrator module 240 receives the outputs of the parser module 230 and the GenAI module 250 and integrates them into a single document. The resulting document may be exported in a variety of formats (e.g., PDF, HTML, DOCX, and the like) by the export module 260.

Data, metadata, documents, instructions, or any suitable combination thereof may be stored and accessed by the storage module 270. For example, local storage of the data modeling server 140, such as a hard drive, may be used. As another example, network storage may be accessed by the storage module 270 via the network 190.

The extraction module 280 may perform the reverse operations of the parser module 230. For example, the extraction module 280 may extract metadata from a unified document that describes the element properties of a data model, generate a JSON document that comprises the metadata, and replicate the data model in another data modeling server system.

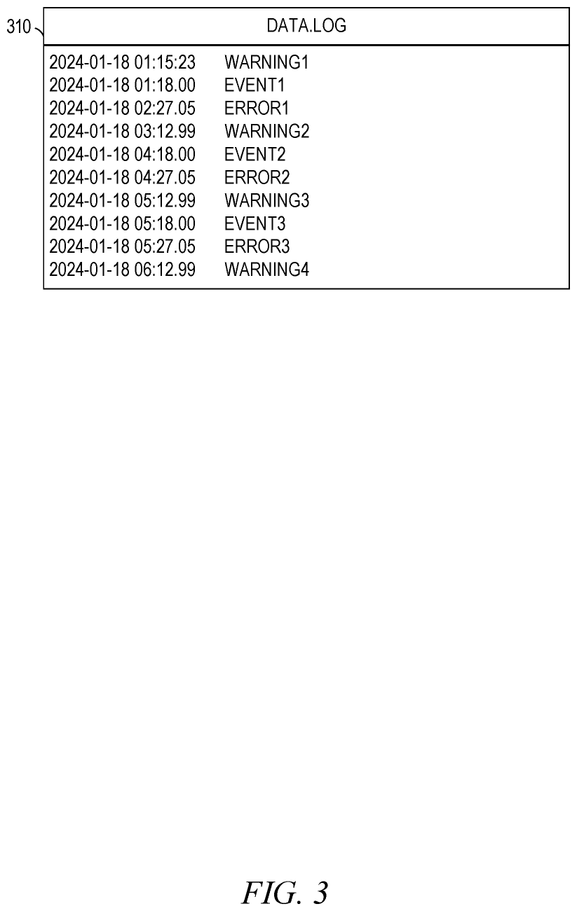

FIG. 3 shows an illustration of a data source in the form of a file 310, according to some example embodiments. The file 310, titled “data.log” stores log data indicating the date and time of events and the type of each event. In this example, the events begin at 1:15 AM on Jan. 18, 2024 and end at 6:12 AM on the same day. The events include several generic events, several warnings, and several errors.

The data modeling server 140 of FIG. 1 may access the file 310 and model it as a database table, allowing the application server 130, also of FIG. 1, to request information about errors, warnings, and events using a software query language (SQL) request. Thus, the application server 130 is enabled to access from the file 310 using the same interface as it uses to access other data sources and an application running on the application server 130 does not need to include customized code for each different data source.

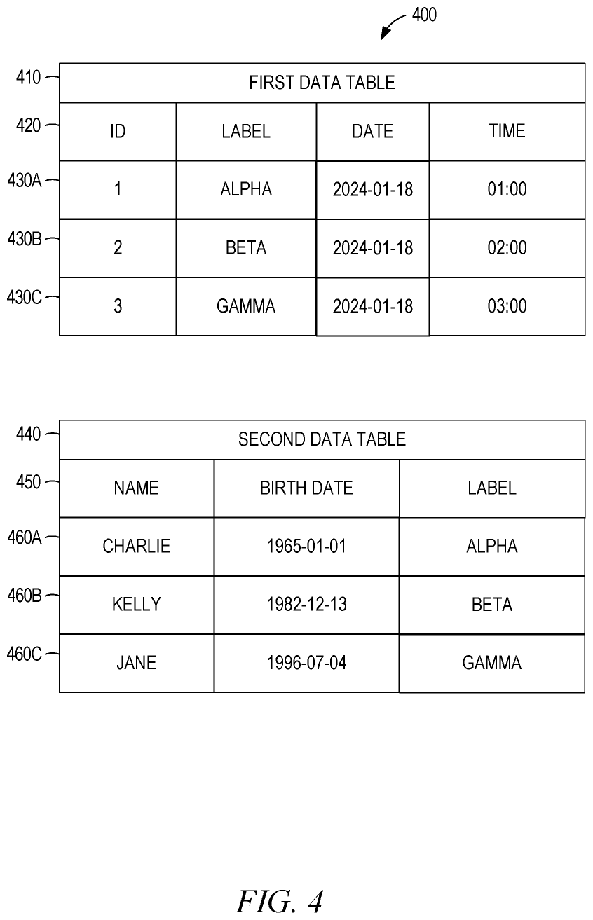

FIG. 4 shows an illustration of a database schema 400, suitable for use as a database data source, according to some example embodiments. The database schema 400 includes a first data table 410 and a second data table 440. The first data table 410 includes rows 430A, 430B, and 430C of a format 420. The second data table 440 includes rows 460A, 460B, and 460C of a format 450.

Each of the rows 430A-430C includes a unique identifier, a label, a date, and a time. Each of the rows 460A-460C includes a name, a birth date, and a label.

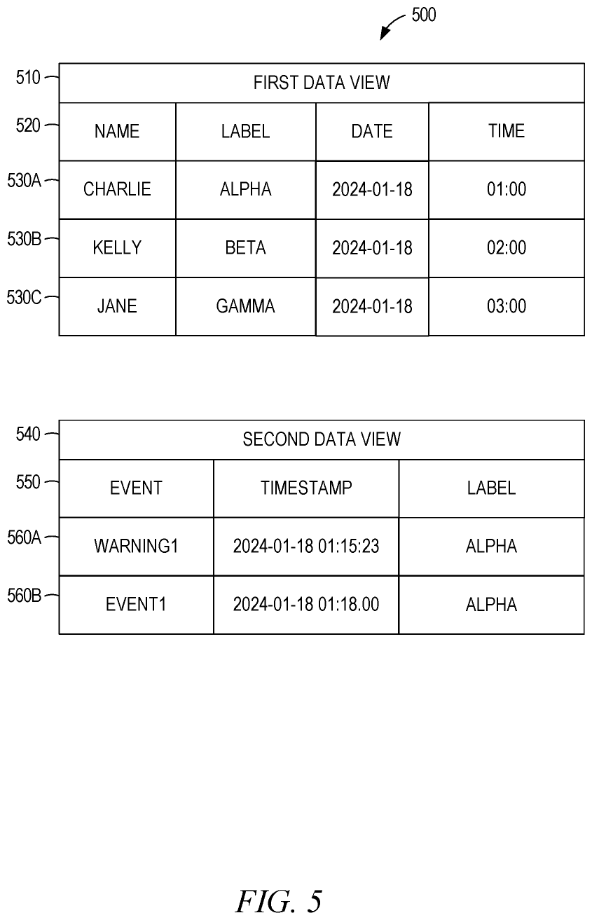

The data modeling server 140 of FIG. 1 may access the tables 410 and 440 and include them in a data model presented to an application running on the application server 130. Example data views are discussed with respect to FIG. 5, below.

FIG. 5 shows an illustration 500 of data views 510 and 540 that combine data from the file data source of FIG. 3 and the database data source of FIG. 4, according to some example embodiments. The first data view 510 includes rows 530A, 530B, and 530C of a format 520. The second data view 540 includes rows 560A and 560B of a format 550. The data modeling server 140 of FIG. 1 generates the data views 510 and 540 from data sources. The application server 130 accesses the data views 510 and 540 instead of accessing the underlying data sources.

The first data view 510 includes data from the first data table 410 and the second data table 440, joined on the label field of the two tables. For example, the row 460A of the second data table 440 and the row 430A of the first data table 410 both include the label “alpha.” Joining the two rows and selecting the name from the row 460A and the date and time from the row 430A results in the row 530A of the first data view 510. Since the joining is performed by the data modeling server 140, the application server 130 is enabled to access the combined data using simpler queries. For example, “SELECT name, label, date, time FROM first_data view WHERE label=‘alpha’” instead of “SELECT second_data_table.name, first_data_table.label, first_data_table.date, first_data_table.time FROM first_data_table, second_data_table WHERE first_data_table.label=second_data_table.label AND first data table.label=‘alpha’”.

The second data view 540 includes data from the file 310 of FIG. 3 and the first data table 410 of FIG. 4. Each row of the second data view 540 includes an event and a timestamp from the file 310 and a label from the first data table 410, where the label is taken from the row of the first data table 410 having date and time values closest to the timestamp for the event. This enables the application server 130 to access data from the file 310 using database queries and also labels the data from the file 310 with additional information drawn from the first table 410.

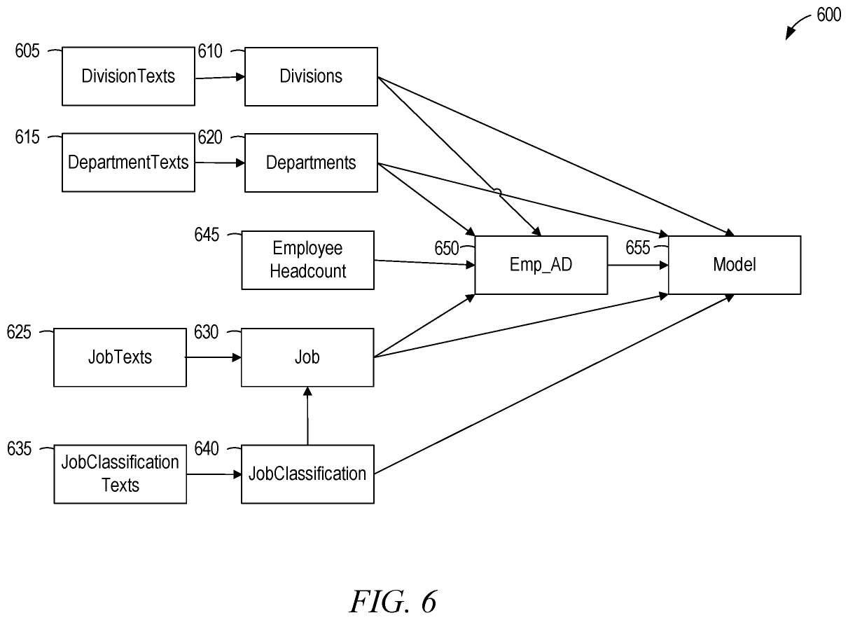

FIG. 6 shows an illustration of a dependency graph 600 that shows relationships between data sources and a data model, according to some example embodiments. The examples of FIGS. 3-5 are simplified for clarity. The example of FIG. 6 is somewhat more detailed. The element 655 represents the model that is generated by the modeling server 140 of FIG. 1. Each of the elements 605, 610, 615, 620, 625, 630, 635, 640, 645, and 650 represents a data table or a view. The model depends, directly or indirectly, on all of the other elements shown in the dependency graph 600, as shown by the relationships between the element 655 and the other elements.

To illustrate, the element 605 may represent a DivisionTexts table that includes text strings used in a Divisions table. The 610 may represent a view that combines data from the Divisions table and the DivisionTexts table, including the text strings for the Divisions instead of string identifiers.

The element 650 represents Emp_AD view that combines data from data sources represented by the elements 610, 620, 630, 640, and 645, for employees, jobs, divisions, and departments. The element 620 represents a Departments view that combines data from a Departments table and a DepartmentTexts table. The element 630 represents a Job view that combines data from a Job table, a JobTexts table, and a JobClassification view. The JobClassification view combines data from a JobClassification table and a JobClassificationTexts table.

The dependency graph 600 may be generated by recursively iterating over the data sources used in the model. For example, the element 655 for the model may be created. Then the definition for the model is analyzed to determine that the model directly gathers data from the Divisions view, the Departments view, the Emp_AD view, the Job view, and the JobClassification view. Based on the definition, the elements 610, 620, 630, 640, and 650 are created and labeled. Then each of the newly added elements 610-650 is analyzed.

For example, a definition of the Divisions view may be analyzed to determine that it depends on the Divisions table and the DivisionTexts table. In response to detecting a dependency on the DivisionTexts table, the system determines whether an element in the dependency graph 600 has already been created for the DivisionTexts table. Since no corresponding element has been created, the element 605 is added. If the new element corresponded to a view, the new element would be added to the list of elements to be processed to detect further dependencies. Since the DivisionTexts table is not a view, it does not depend on other tables and no further search is needed.

This process is repeated until all of the elements 605-650 are created and no further dependencies are found. At that point, the dependency graph 600 has been created and shows all of the data sources that are used, directly or indirectly, by the model.

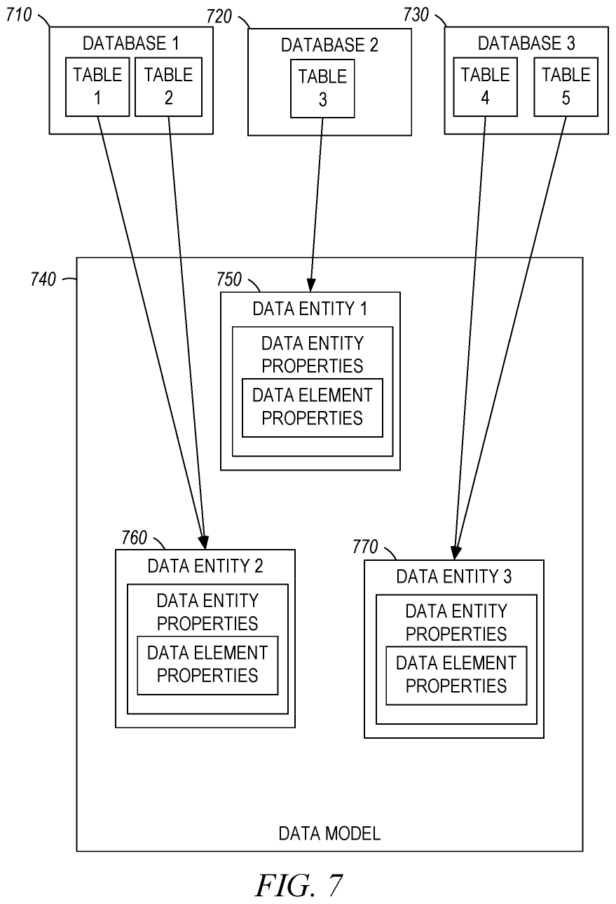

FIG. 7 shows an illustration of a data model 740 of the data modeling server 140 of FIG. 1, according to some example embodiments. FIG. 7 includes databases 710, 720, and 730; and data entities 750, 760, and 770.

The data modeling server 140 is a comprehensive data service provider that enables data professionals to integrate data from different databases and enhance data by performing data modeling using data models. The databases 710-730 may be provided by different database servers (e.g., the database servers 150A-150B of FIG. 1), use different types of databases (e.g., an in-memory database, an SQL database, an object-oriented database, a distributed database, and the like), or any suitable combination thereof. The database 710 includes two tables that are used to create the data entity 760. The database 720 includes one table that is used to create the data entity 750. The database 730 includes two tables that are used to create the data entity 770. Each of the data entities 750-700 comprises data entity properties that are further composed of data element properties.

A data model (e.g., the data model 740) combines data from tables or views of multiple databases (e.g., the databases 710-730). A data model definition for the data model 740 describes elements used to standardize the system, such as associations, entities, hierarchies, and the like. The element 655 of FIG. 6 represents a data model. In an embodiment, a storage space may include multiple data models (e.g. data model 740). The storage space may be a virtual work environment for a corresponding business segment (e.g. finance, sales, information technology support, human resource, administration, transport, facilities etc.). These storage spaces may have corresponding users assigned to access these spaces. These storage spaces may maintain sub-storage space (virtual storage space partitions) and connections to data sources.

Data sources are database systems that have tables and views and to which the data modeling server 140 connects to fetch the tables and views and their data. A data entity is a combination of multiple database tables or views from one or more database systems. The properties of each data entity contains measures (numeric values), dimensions, filters, variables, and the like. Each entity property has one or more elements. A data element is a basic unit of information that has a unique meaning and subcategories of distinct value. An example of a data element property is a calculated column with calculation expression and aggregation.

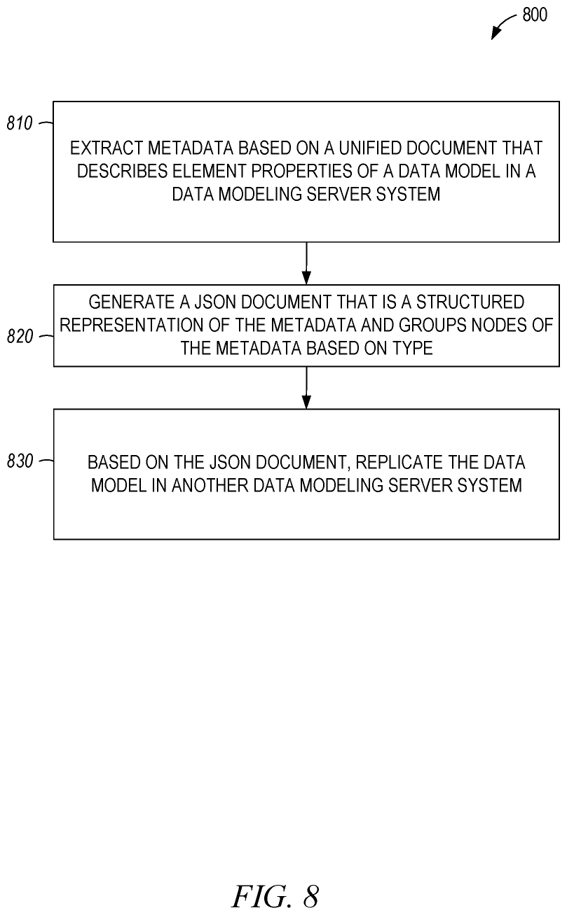

FIG. 8 shows a flowchart illustrating operations of an example method 800 suitable for replicating a data model based on a document having element properties of a data model, according to some example embodiments. By way of example and not limitation, the method 800 is described as being performed by the extraction module 280 of FIG. 2. The method 800 includes operations 810, 820, and 830.

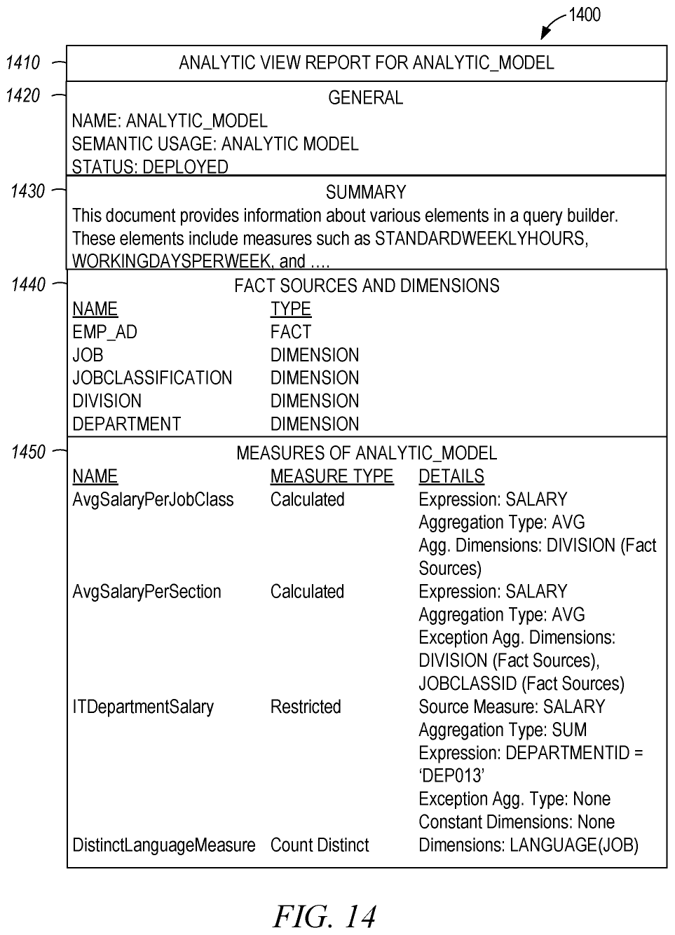

In operation 810, the extraction module 280 extracts metadata based on a unified document that describes element properties of a data model in a data modeling server system. For example, the document of FIGS. 14-17 may be accessed.

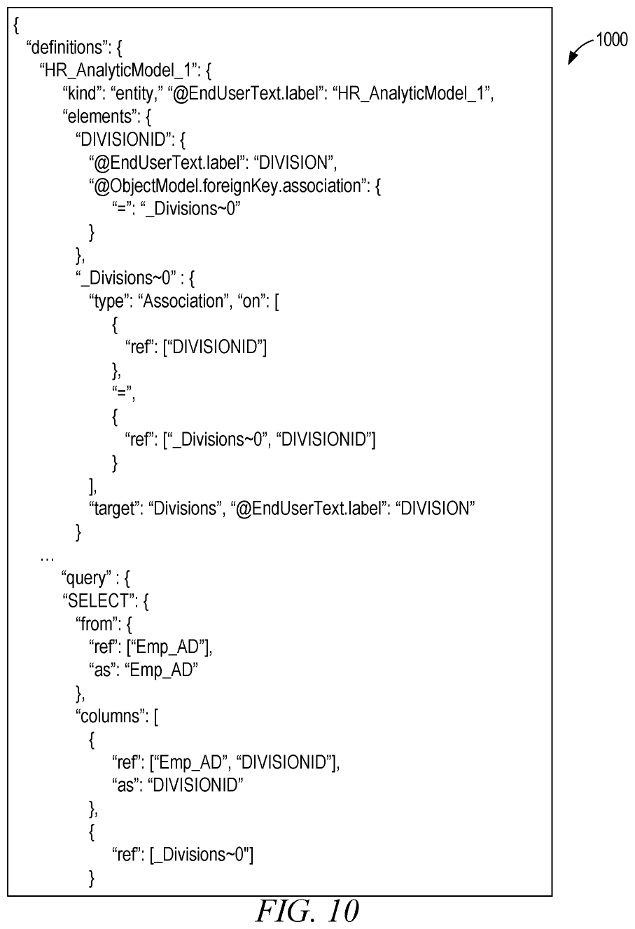

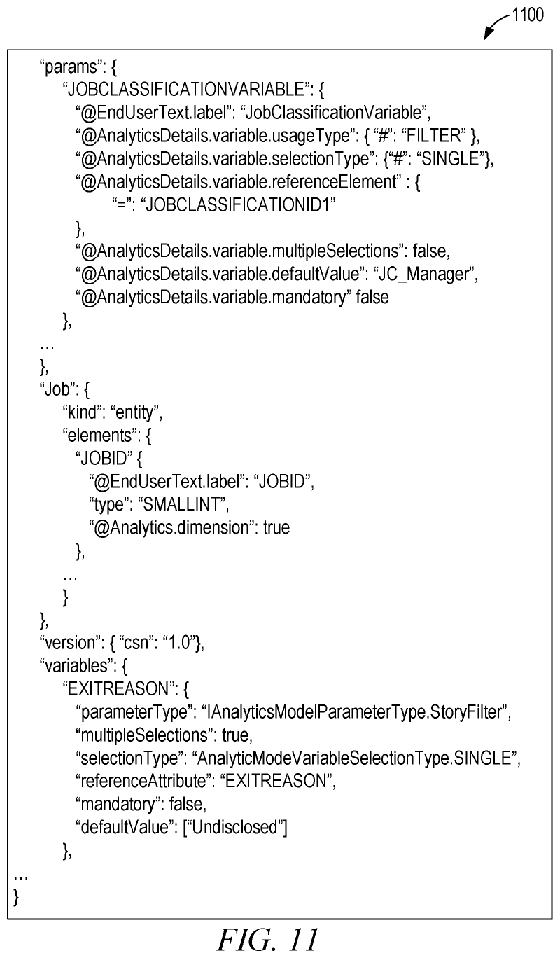

The extraction module 280, in operation 820, generates a JSON document that is a structured representation of the metadata and groups nodes of the metadata based on type. For example, the JSON of FIGS. 10-11 may be generated.

In operation 830, based on the JSON document, the extraction module 280 replicates the data model in another data modeling server system. Thus, the document of FIGS. 14-17 may be used to automatically replicate a data model from the data modeling server 140 of FIG. 1 to another data modeling server system, avoiding the possibility of user error.

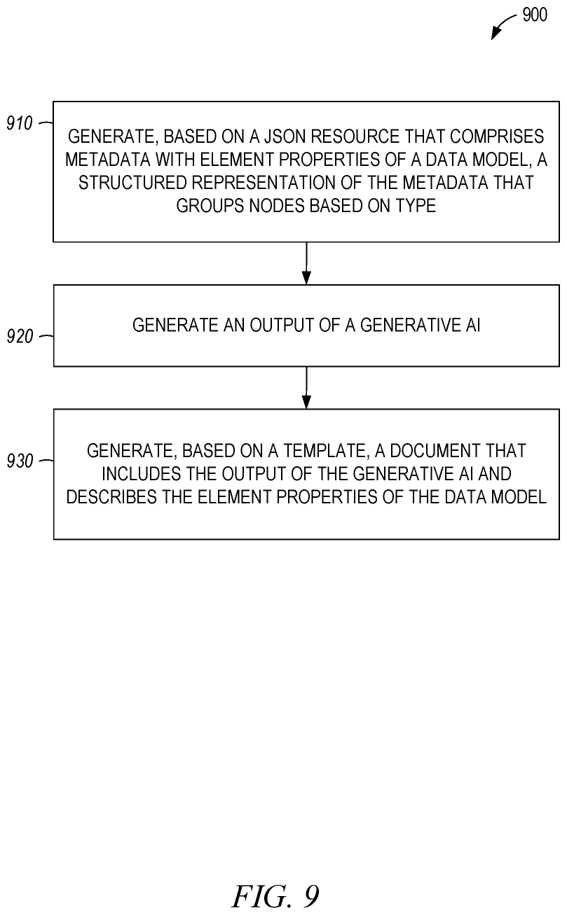

FIG. 9 shows a flowchart illustrating operations of an example method 900 suitable for automatically generating a document with element properties of data models. The method 900 includes operation 910, 920, and 930. By way of example and not limitation, the method 900 is described as being performed by the data modeling server 140 of FIG. 1, using the modules of FIG. 2, the file 310 of FIG. 3, the database schema 400 of FIG. 4, and the data views of FIG. 5.

In operation 910, the parser module 230 of the data modeling server 140 generates, based on a JSON resource that comprises metadata of element properties of a data model, a structured representation of the metadata that groups nodes based on type. In addition to the element properties of the data model, status information, owner information, storage space information, configuration details of the space etc. may be included.

For example, each node may have a type selected from: base, calculation, restriction, formula, and aggregation. A base node contains unmodified data from a data source. To illustrate, if the first data table 410 were included without modification in a data model, the corresponding node in the metadata for the data model would indicate a type of “base.”

A calculation node applies a formula to data from a data source. For example, if a table of a data source contains data indicating values in dollars and the table presented in the data model included values in euros instead, the node for the resulting table would be of type “calculation.”

A restriction node includes base or calculation data only for a subset of the input data from the data source. For example, if a table of a data source contains information for many countries but the data model presents data for only one country, the node would be of type “restriction.”

A formula node defines a formula that is applied by a calculation node. An aggregation node combines data from multiple rows of a table into a single row. For example, a maximum, minimum, average, or sum of a field in multiple rows may be determined to aggregate the data from the rows. To illustrate, an input data table may include a row for each expenditure made, along with the date on which the expenditure was made. The output data table may include one row for each year, with the total of expenditures made in the year, aggregating the data for all of the rows having dates in the year.

Thus, the generating of the structured representation of the metadata that groups node based on type may include generating a first portion of the structured representation of the metadata for a first group of nodes of base data, generating a second portion of the structured representation of the metadata for a second group of nodes of restricted data, and generating a third portion of the structured representation of the metadata for a third group of nodes of calculated data.

In operation 920, the GenAI module 250 generates an output of a GenAI. For example, a user interface may be presented that allows a user to enter one or more prompts for a GenAI. The prompts are provided to the GenAI and an output generated in operation 920.

The integrator module 240, in operation 930, generates, based on a template, a document that includes the output of the GenAI and describes the element properties and storage space details of the data model.

The method 900 may be reversible. For example, the data modeling server 140 may parse the document generated in operation 930 to recreate the structured representation of the metadata that groups nodes based on type. Using the structured representation of the metadata, a JSON resource that defines a data model may be created by the extraction module 280. Accordingly, based on the generated document, the data modeling server 140 (or a different data modeling server) is enabled to replicate or recreate the data model.

FIGS. 10-11 show example portions 1000 and 1100 of a file containing a JSON resource suitable for automatically generating a document with element properties of data models. In JSON, matching pairs of curly braces define objects. Matching pairs of square braces define arrays and can contain one or more elements. Elements of arrays can be accessed using numerical indices. Many elements are defined as key-value pairs, with the key and value separated by a colon.

The JSON file can be parsed in a hierarchical fashion, with contained elements identified using dot notation. For example, the first element in the portion 1000 is named “definitions.” The first object within the “definitions” is “HR_AnalyticModel_1.” This object can also be referred to as “definitions.HR_Analytic_Model_1.” The HR_AnalyticModel_1 object has its own elements, such as “kind,” “@EndUserText.label,” and “elements.”

The JSON resource includes a “query” object that includes metadata describing the query, including the contents of the SELECT statement, such as the tables being accessed, the columns being retrieved, the filters being applied, and the like.

The portion 1100 of the file shown in FIG. 11 shows a “params” (parameters) object, a “Job” object, a “version” object, and a “variables” object. The “params” object provides metadata regarding a variable named “JobClassification Variable.” The “Job” object provides metadata for a Job, including the elements of a Job, such as the JobId. The metadata for each element can include a type of the element, such as SMALLINT, in this example.

The “version” object may identify the version of the JSON resource or the version of the software used to create the JSON resource. The “variables” object may define variables used in the model. For example, the “EXITREASON” variable can access data from an “EXITREASON” attribute in a data source and, if no data is found, define the default value as “Undisclosed.”

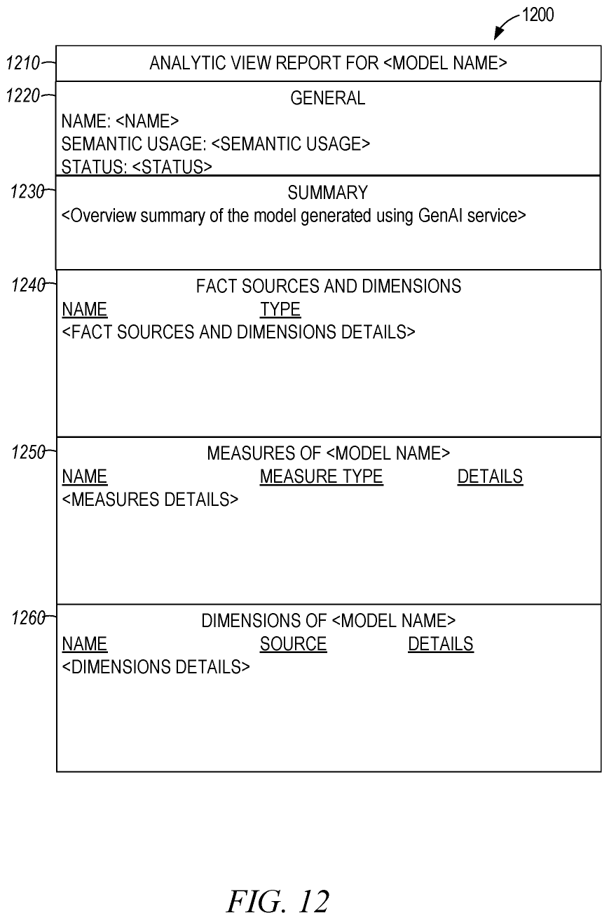

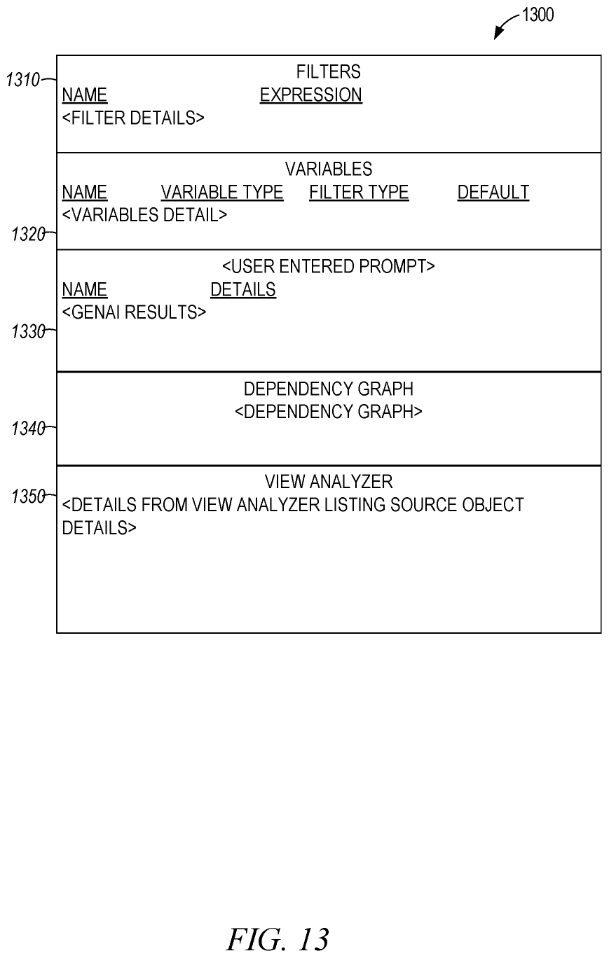

In practice, the JSON resource may comprise hundreds or thousands of objects, data sources, variables, filters, tables, and the like. A template file, such as that shown in FIGS. 12-13 may instruct the data modeling server 140 of FIG. 1 as to which data to gather from the JSON resource and include in a report, making the complexity of the JSON resource more manageable for users.

FIGS. 12-13 show an example of a template for automatically generating a document showing element properties of data models. The portion 1200 in FIG. 12 includes sections 1210, 1220, 1230, 1240, 1250, and 1260. The portion 1300 in FIG. 13 includes sections 1310, 1320, 1330, 1340, and 1350. The template may be stored as a file on a file system of the data modeling server 140 of FIG. 1.

The integrator module 240 of FIG. 2 may access the template and parse it. Text elements in angle brackets may identify data provided to the integrator module 240 from the parser module 230 or the GenAI module 250. The text in the angle brackets may be replaced by the identified data in a generated document that shows element properties of data models. Text elements not in angle brackets may be reproduced verbatim in the generated document.

Section 1210 is a title for the generated document and includes a <MODEL NAME> element that is replaced in the generated document by a model name extracted from the metadata for the model. Section 1220 includes additional general information for the model, such as model name, storage space name, storage space information, roles associated with memory space, semantic usage, and status. For example, in data modeling server, a user may create multiple storage spaces per associated group (e.g. 50 GB for Human Resource data, 50 GB for Facilities data, 70 GB for administrative data, etc.). Each user can be given role-based access to the storage spaces. The information for section 1220 is also extracted from the metadata for the model.

A summary for the model is presented in section 1230. The summary is generated by the GenAI module 250 based on the metadata for the model, such as from the “definitions” object shown in FIG. 8. The fact sources and dimensions are presented in section 1240. The measures and dimensions are presented in sections 1250 and 1260, respectively. The information for sections 1240-1260 is extracted from the metadata for the model. As can be seen in FIG. 12, the headers for the columns of data that will be included in the generated document are specified in the template.

Sections 1310 and 1320 provide information regarding filters and variables used by the model. Such information is extracted by the parser module 230 from the metadata for the model.

A user-entered prompt may be received along with a request to generate the document. As shown in section 1330, the received prompt may be included in the generated document, along with output from the GenAI module 250 resulting from the prompt.

The dependency graph 600 of FIG. 6 may be generated by the parser module 230 based on the metadata for the model and included in section 1340 in response to the <DEPENDENCY GRAPH> token. A view analyzer section 1350 includes information generated by the parser module 230 with source object details. By reading different template files, the integrator module 250 may be configured to generate documents with different information or with information in a different order, increasing the utility of the generated document for particular users.

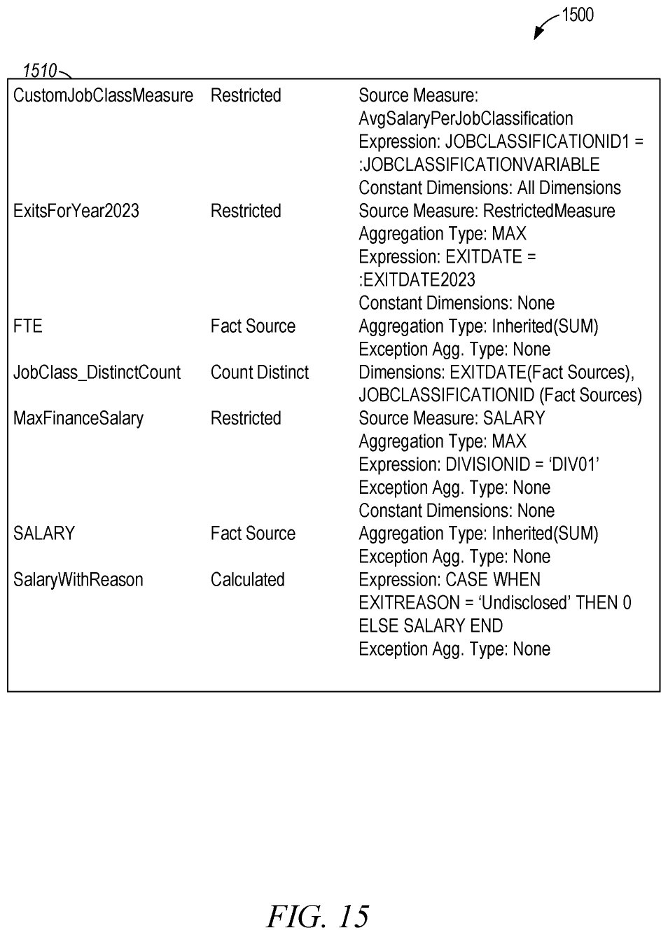

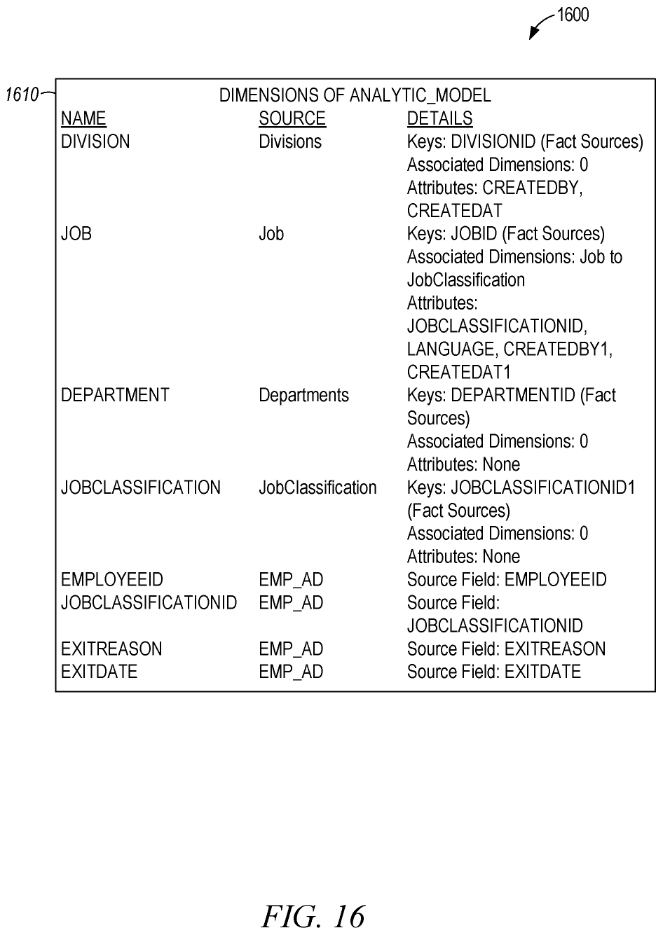

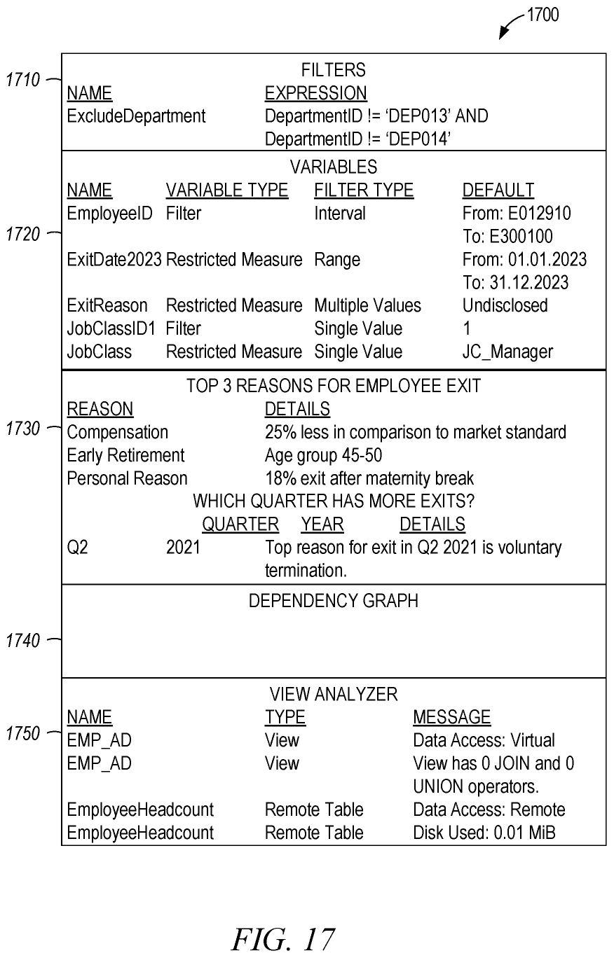

FIGS. 14-17 show an example of an automatically generated document with element properties of data models. FIG. 14 shows a portion 1400, FIG. 15 shows a portion 1500, FIG. 16 shows a portion 1600, and FIG. 17 shows a portion 1700 of the automatically generated document. By comparison with the template of FIGS. 12-13, the automatically generated document of FIGS. 14-17 includes data for the specific data model in place of the angle-bracketed tokens. Other text is transferred literally from the template to the automatically generated document.

Sections 1410, 1420, 1430, 1440, and 1450 of the portion 1400 are generated by the integrator module 250 of FIG. 2 based on the sections 1210-1250 of the portion 1200 of FIG. 12. The section 1450 shows several measures of the model, with information including name, measure type, and details.

For example, the AvgSalaryPerJobClass measure is a calculated measure that includes the average (“AVG”) salary, aggregated for each division. Thus, a user of a consuming application of the data model does not have to expressly perform the aggregation, but merely accesses the AvgSalaryPerJobClass calculated measure as an ordinary data element. Without reference to the generated document of FIGS. 14-17, a user of the consuming application could not be sure of what aggregations are used or which dimensions are used for aggregation for AvgSalaryPerJobClass calculated measure. For example, a user might assume that the referenced “job class” referred to a department rather than a division, or further divided classification by years of experience, country, or the like.

The AvgSalaryPerSection measure is a calculated measure with exception aggregation. As seen in the section 1450, the AvgSalaryPerSection uses an average aggregation of the SALARY value. The exception aggregation provides further instructions to the data model as to how to generate the average, rather than simply taking an average of all salaries to generate a single value. In this example, the salary data is aggregated for each unique combination of DIVISION and JOBCLASSID, the dimensions of the exception aggregation. Thus, the generated document may describe a calculated measure with exception aggregation.

The generated document may also describe a restricted measure without constant selection, such as the ITDepartmentSalary measure. The ITDepartmentSalary takes data from the SALARY source and aggregates it by taking a sum of values. However, the ITDepartmentSalary does not sum all of the salaries available, but only those with DEPARTMENTID=‘DEP013,’ as shown by the corresponding expression in the section 1450. The ITDepartmentSalary is a restricted measure because it does not include all values from the source, but only those that match the expression. As can be seen in the section 1450, the ITDepartmentSalary does not include any constant dimensions, and thus is without constant selection.

A constant selection of all or a subset of dimensions affects the data that is shown as the user changes which portion of the available data is accessed. For example, the ITDepartmentSalary shows the sum of salaries in DEP013, the IT Department. If the user were to access employee data for a single country or state, the ITDepartmentSalary data reported would be the sum of IT salaries for the selected geographic region.

As shown by way of example with the ITDepartmentSalary measure, the generated document may describe a restricted measure without constant selection. Alternatively, if the geographic location were added as a constant dimension, the reported ITDepartmentSalary would not change as the user accesses different geographic regions.

The DistinctLanguageMeasure is a count distinct measure with a value of the number of different values in the identified dimensions. In this example, the DistinctLanguageMeasure counts the different number of languages used in the JOB source.

Section 1510 of the portion 1500, in FIG. 15, is a continuation of the section 1450 of FIG. 14. Included in the section 1510 is information about CustomJobClassMeasure, ExitsForYear2023, FTE, JobClass_DistinctCount, MaxFinanceSalary, SALARY, and Salary WithReason. These provide additional examples of measure variables.

The CustomJobClassMeasure is, like the ITDepartmentSalary, a restricted measure. The restriction is shown in the expression, JOBCLASSIFICATIONID1=:JOBCLASSIFICATIONVARIABLE. Unlike the ITDepartmentSalary measure, the CustomJobClassMeasure uses a customized expression and constant dimensions. The source for the CustomJobClassMeasure is the AvgSalaryPerJobClassification, and the value will not change depending on the data accessed, because all dimensions are constant dimensions. Accordingly, the generated document may describe a restricted measure with constant selection of all dimensions.

The value of the JOBCLASSIFICATIONVARIABLE used in the CustomJobClassMeasure may be customized (e.g., set by a user). Thus, the CustomJobClassMeasure uses a variable expression for its restriction. The JOBCLASSIFICATIONVARIABLE is used to define the restriction on the measure and may be referred to as a restricted variable. Accordingly, the generated document may describe a restricted measure using a restricted variable.

Another restricted, customized measure is the ExitsForYear2023. However, the ExitsForYear2023 measure does not use constant dimensions.

MaxFinanceSalary determines the maximum value from the SALARY source where DIVISIONID=‘DIV01.’ There are no exceptions or constant dimensions.

Salary WithReasons is a calculated measure that evaluates the corresponding expression. When the EXITREASON is Undisclosed, the Salary WithReasons value is 0. Otherwise, the SALARY value is used.

JobClass_DistinctCount is a count distinct measure that uses multiple dimensions. For each different EXITDATE, JobClass_DistinctCount will count the number of different JOBCLASSIFICATIONIDs. Thus, the generated document may describe a count distinct measure with one or more dimensions.

Section 1610 of the portion 1600 is generated by the integrator module 250 based on the section 1260 of the portion 1200 of FIG. 12. The section 1610 shows the dimensions of the model, with information including name, source, and details.

For example, the JOB dimension is taken from a Job data source and includes JOBCLASSIFICATIONID, LANGUAGE, CREATEDBY1, and CREATEDAT1 fields. The fields included may be a subset of those included in the Job data source.

Portion 1700 of FIG. 17 includes sections 1710, 1720, 1730, 1740, and 1750. The sections 1710-1750 correspond to the sections 1110-1150 of FIG. 11. The section 1730 includes user-provided prompts to a GenAI and the resulting outputs. The section 1740 includes the dependency graph for the data model, such as the example dependency graph 600 of FIG. 6.

A user accessing the generated document of FIGS. 14-17 has a greater understanding of the information in the model for which the document is generated. For example, section 1720 shows that the EmployeeID filter only includes information for employee numbers E012910 to E300100. Accordingly, if the user needs information for employees outside of that range, referencing the document will inform them that they need to use another field or request changes to the data model.

The ExitDate2023 restricted measure variable is a restricted measure variable that uses a range filter, dealing only with records dated in 2023. As shown by this example, the automatically generated document may describe a restricted measure variable with a filter comprising one or more ranges.

By contrast, the JobClass restricted measure variable is a restricted measure variable with a filter comprising one or more values, in this case, the single value of JC_Manager. As shown by this example, the automatically generated document may describe a restricted measure variable with a filter comprising one or more values.

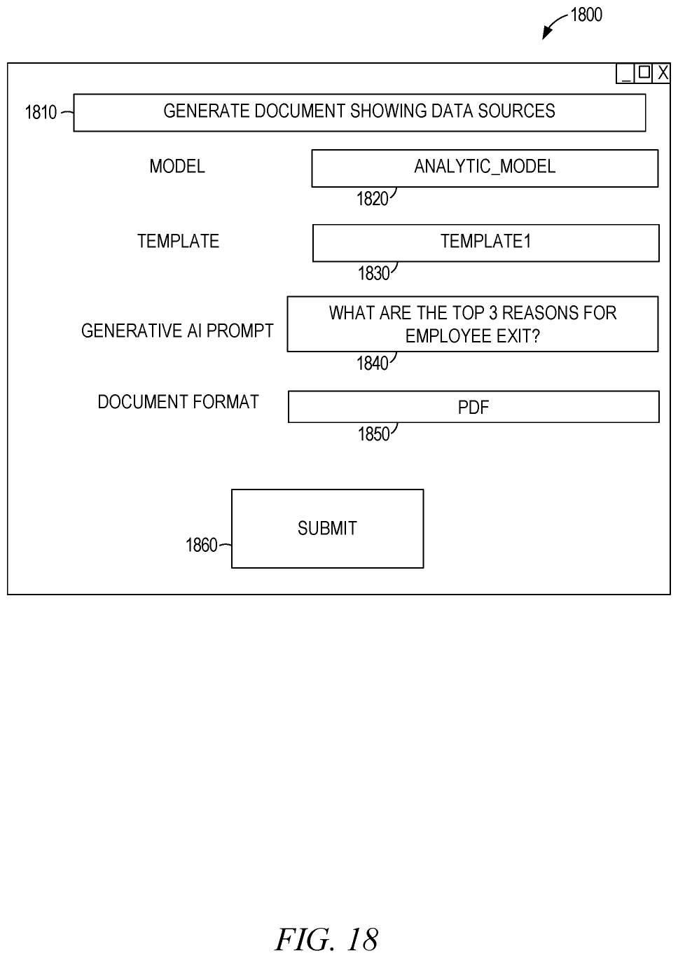

FIG. 18 shows an illustration of a user interface 1800 for generating a document having element properties of a data model, according to some example embodiments. The user interface 1800 includes a title 1810, a model selector 1820, a template selector 1830, a text field 1840, a format selector 1850, and a button 1860. The user interface 1800 may be generated by the data modeling server 140 and presented on a display device of one of the client devices 160A-160B, all of FIG. 1.

The title 1810 indicates that the user interface 1800 is for generating a document with element properties of data models. The model selector 1820 is operable by a user to select a model for which the document is generated. Similarly, the template selector 1830 is operable by the user to select a template to be used to generate the document. The model selector 1820 and the template selector 1830 may be implemented as drop-down selectors, text fields, combo boxes, or any suitable combination thereof.

A prompt to be provided to a GenAI may be entered by the user into the text field 1840. The format selector 1850 is operable by the user to select a format of the generated document, such as PDF, HTML, TXT, and the like.

In response to detecting an interaction with the button 1860, the data modeling server 140 begins the generation of the document. For example, the model selected using the model selector 1820 may have a corresponding JSON file that defines a JSON resource containing metadata for the model. The modeling server 140 extracts information for the model from the JSON resource. Based on the selected template, a document is generated that includes at least a subset of the extracted information.

The metadata for the model identifies element properties of data models, such as measures, calculated measures, restricted measures and the like. The prompt received in the text field 1840 is provided to a GenAI. The GenAI model may be provided at least a subset of the identified data sources as context for the prompt. The results from the GenAI are included in the document, if so indicated by the selected template. The document is provided to the user in the format selected by the format selector 1850.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: generating, based on a JavaScript Object Notation (JSON) resource that comprises metadata for element properties of a data model, a structured representation of the metadata that groups nodes based on type; generating an output of a generative artificial intelligence (AI); and generating, based on a template, a document that includes, the output of the generative AI and describes the element properties of the data model.

In Example 2, the subject matter of Example 1, wherein the operations further comprise: receiving a prompt for the generative AI; providing at least a subset of the element properties to the generative AI; and providing the prompt to the generative AI.

In Example 3, the subject matter of Examples 1-2, wherein the generating of the structured representation of the metadata that groups nodes based on type comprises: generating a first portion of the structured representation of the metadata for a first group of nodes of base data; generating a second portion of the structured representation of the metadata for a second group of nodes of restricted data; generating a third portion of the structured representation of the metadata for a third group of nodes of calculated data; generating a fourth portion of the structured representation of the metadata for a fourth group of nodes of filter element data; and generating a fifth portion of the structured representation of the metadata for a fifth group of nodes of variable element data.

In Example 4, the subject matter of Examples 1-3, wherein the generating of the document comprises generating the document in portable document format (PDF) or hypertext markup language (HTML).

In Example 5, the subject matter of Examples 1-4, wherein the operations further comprise: based on the generated document, duplicating the data model.

In Example 6, the subject matter of Examples 1-5, wherein the document describes a calculated measure with exception aggregation.

In Example 7, the subject matter of Examples 1-6, wherein the document describes a restricted measure without constant selection.

In Example 8, the subject matter of Examples 1-7, wherein the document describes a restricted measure with constant selection of all dimensions.

In Example 9, the subject matter of Examples 1-8, wherein the document describes a restricted measure using a restricted variable.

In Example 10, the subject matter of Examples 1-9, wherein the document describes a count distinct measure with one or more dimensions.

In Example 11, the subject matter of Examples 1-10, wherein the document describes a restricted measure variable with a filter comprising one or more values.

In Example 12, the subject matter of Examples 1-11, wherein the document describes a restricted measure variable with a filter comprising one or more ranges.

Example 13 is a non-transitory computer-readable medium that stores instructions that, when executed by one or more processors, cause the one or more processors to perform operations comprising: generating, based on a JavaScript Object Notation (JSON) resource that comprises metadata for element properties of a data model, a structured representation of the metadata that groups nodes based on type; generating an output of a generative artificial intelligence (AI); and generating, based on a template, a document that includes, the output of the generative AI and describes the element properties of the data model.

In Example 14, the subject matter of Example 13, wherein the operations further comprise: receiving a prompt for the generative AI; providing at least a subset of the element properties to the generative AI; and providing the prompt to the generative AI.

In Example 15, the subject matter of Examples 13-14, wherein the generating of the structured representation of the metadata that groups nodes based on type comprises: generating a first portion of the structured representation of the metadata for a first group of nodes of base data; generating a second portion of the structured representation of the metadata for a second group of nodes of restricted data; generating a third portion of the structured representation of the metadata for a third group of nodes of calculated data; generating a fourth portion of the structured representation of the metadata for a fourth group of nodes of filter element data; and generating a fifth portion of the structured representation of the metadata for a fifth group of nodes of variable element data.

In Example 16, the subject matter of Examples 13-15, wherein the generating of the document comprises generating the document in portable document format (PDF) or hypertext markup language (HTML).

In Example 17, the subject matter of Examples 13-16, wherein the operations further comprise: based on the generated document, replicating or recreating the data model.

Example 18 is a method comprising: generating, by one or more processors and based on a JavaScript Object Notation (JSON) resource that comprises metadata for element properties of a data model, a structured representation of the metadata that groups nodes based on type; generating, by the one or more processors, an output of a generative artificial intelligence (AI); and generating, by the one or more processors and based on a template, a document that includes, the output of the generative AI and describes the element properties of the data model.

In Example 19, the subject matter of Example 18, wherein the document describes a calculated measure with exception aggregation.

In Example 20, the subject matter of Examples 18-19, wherein the document describes a restricted measure without constant selection.

Example 21 is an apparatus comprising means to implement any of Examples 1-20.

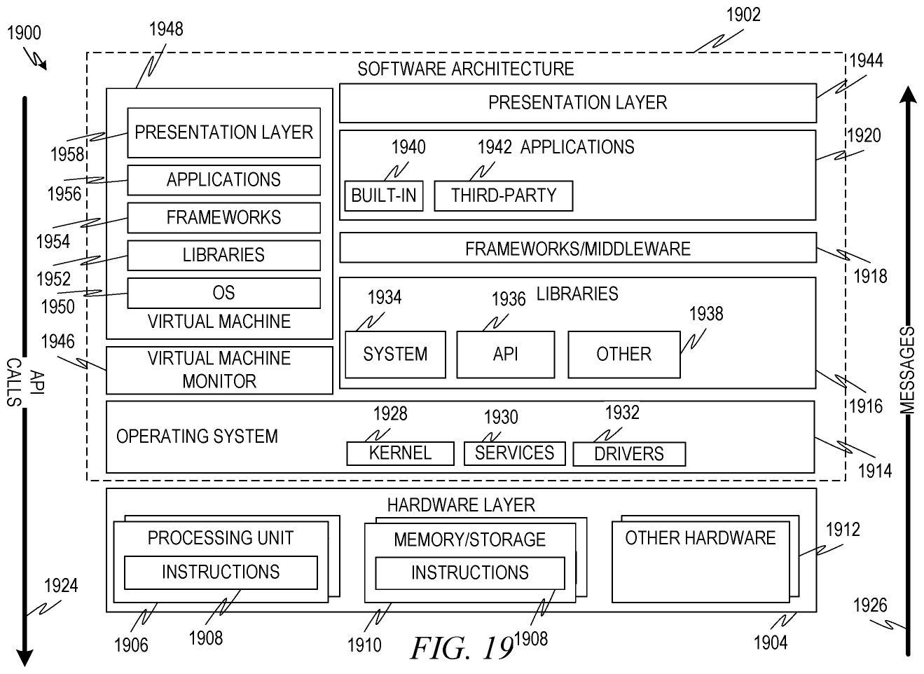

FIG. 19 shows a block diagram 1900 showing one example of a software architecture 1902 for a computing device. The software architecture 1902 may be used in conjunction with various hardware architectures, for example, as described herein. FIG. 19 is merely a non-limiting example of a software architecture, and many other architectures may be implemented to facilitate the functionality described herein. A representative hardware layer 1904 is illustrated and can represent, for example, any of the above referenced computing devices. In some examples, the hardware layer 1904 may be implemented according to the architecture of the computer system of FIG. 19.

The representative hardware layer 1904 comprises one or more processing units 1906 having associated executable instructions 1908. Executable instructions 1908 represent the executable instructions of the software architecture 1902, including implementation of the methods, modules, subsystems, and components, and so forth described herein and may also include memory and/or storage modules 1910, which also have executable instructions 1908. Hardware layer 1904 may also comprise other hardware as indicated by other hardware 1912 which represents any other hardware of the hardware layer 1904, such as the other hardware illustrated as part of the software architecture 1902.

In the example architecture of FIG. 19, the software architecture 1902 may be conceptualized as a stack of layers where each layer provides particular functionality. For example, the software architecture 1902 may include layers such as an operating system 1914, libraries 1916, frameworks/middleware 1918, applications 1920, and presentation layer 1944. Operationally, the applications 1920 and/or other components within the layers may invoke application programming interface (API) calls 1924 through the software stack and access a response, returned values, and so forth illustrated as messages 1926 in response to the API calls 1924. The layers illustrated are representative in nature and not all software architectures have all layers. For example, some mobile or special purpose operating systems may not provide a frameworks/middleware 1918 layer, while others may provide such a layer. Other software architectures may include additional or different layers.

The operating system 1914 may manage hardware resources and provide common services. The operating system 1914 may include, for example, a kernel 1928, services 1930, and drivers 1932. The kernel 1928 may act as an abstraction layer between the hardware and the other software layers. For example, the kernel 1928 may be responsible for memory management, processor management (e.g., scheduling), component management, networking, security settings, and so on. The services 1930 may provide other common services for the other software layers. In some examples, the services 1930 include an interrupt service. The interrupt service may detect the receipt of an interrupt and, in response, cause the software architecture 1902 to pause its current processing and execute an interrupt service routine (ISR) when an interrupt is accessed.

The drivers 1932 may be responsible for controlling or interfacing with the underlying hardware. For instance, the drivers 1932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1916 may provide a common infrastructure that may be utilized by the applications 1920 and/or other components and/or layers. The libraries 1916 typically provide functionality that allows other software modules to perform tasks in an easier fashion than to interface directly with the underlying operating system 1914 functionality (e.g., kernel 1928, services 1930 and/or drivers 1932). The libraries 1916 may include system libraries 1934 (e.g., C standard library) that may provide functions such as memory allocation functions, string manipulation functions, mathematic functions, and the like. In addition, the libraries 1916 may include API libraries 1936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1916 may also include a wide variety of other libraries 1938 to provide many other APIs to the applications 1920 and other software components/modules.

The frameworks/middleware 1918 may provide a higher-level common infrastructure that may be utilized by the applications 1920 and/or other software components/modules. For example, the frameworks/middleware 1918 may provide various graphic user interface (GUI) functions, high-level resource management, high-level location services, and so forth. The frameworks/middleware 1918 may provide a broad spectrum of other APIs that may be utilized by the applications 1920 and/or other software components/modules, some of which may be specific to a particular operating system or platform.

The applications 1920 include built-in applications 1940 and/or third-party applications 1942. Examples of representative built-in applications 1940 may include, but are not limited to, a contacts application, a browser application, a book reader application, a location application, a media application, a messaging application, and/or a game application. Third-party applications 1942 may include any of the built-in applications as well as a broad assortment of other applications. In a specific example, the third-party application 1942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1942 may invoke the API calls 1924 provided by the mobile operating system such as operating system 1914 to facilitate functionality described herein.

The applications 1920 may utilize built in operating system functions (e.g., kernel 1928, services 1930 and/or drivers 1932), libraries (e.g., system libraries 1934, API libraries 1936, and other libraries 1938), and frameworks/middleware 1918 to create user interfaces to interact with users of the system. Alternatively, or additionally, in some systems, interactions with a user may occur through a presentation layer, such as presentation layer 1944. In these systems, the application/module “logic” can be separated from the aspects of the application/module that interact with a user.

Some software architectures utilize virtual machines. In the example of FIG. 19, this is illustrated by virtual machine 1948. A virtual machine creates a software environment where applications/modules can execute as if they were executing on a hardware computing device. A virtual machine is hosted by a host operating system (operating system 1914) and typically, although not always, has a virtual machine monitor 1946, which manages the operation of the virtual machine 1948 as well as the interface with the host operating system (i.e., operating system 1914). A software architecture executes within the virtual machine 1948 such as an operating system 1950, libraries 1952, frameworks/middleware 1954, applications 1956 and/or presentation layer 1958. These layers of software architecture executing within the virtual machine 1948 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 20 shows a block diagram of a machine in the example form of a computer system 2000 within which instructions 2024 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU), a graphics processing unit (GPU), or both), a main memory 2004, and a static memory 2006, which communicate with each other via a bus 2008. The computer system 2000 may further include a video display unit 2010 (e.g., a liquid crystal display (LCD) or a cathode ray tube [CRT]). The computer system 2000 also includes an alphanumeric input device 2012 (e.g., a keyboard or a touch-sensitive display screen), a user interface (UI) navigation (or cursor control) device 2014 (e.g., a mouse), a storage unit 2016, a signal generation device 2018 (e.g., a speaker), and a network interface device 2020.

### Machine-Readable Medium

The storage unit 2016 includes a machine-readable medium 2022 on which is stored one or more sets of data structures and instructions 2024 (e.g., software) embodying or utilized by any one or more of the methodologies or functions described herein. The instructions 2024 may also reside, completely or at least partially, within the main memory 2004 and/or within the processor 2002 during execution thereof by the computer system 2000, with the main memory 2004 and the processor 2002 also constituting a machine-readable medium 2022.

While the machine-readable medium 2022 is shown in FIG. 20 to be a single medium, the term “machine-readable medium” may include a single medium or multiple media (e.g., a centralized or distributed database, and/or associated caches and servers) that store the one or more instructions 2024 or data structures. The term “machine-readable medium” shall also be taken to include any tangible medium that is capable of storing, encoding, or carrying instructions 2024 for execution by the machine and that cause the machine to perform any one or more of the methodologies of the present disclosure, or that is capable of storing, encoding, or carrying data structures utilized by or associated with such instructions 2024. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 2024 may further be transmitted or received over a communications network 2026 using a transmission medium. The instructions 2024 may be transmitted using the network interface device 2020 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 2024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors coupled to the memory and configured to execute the instructions to perform operations comprising:
generating, based on a JavaScript Object Notation (JSON) resource that comprises metadata for element properties of a data model, a structured representation of the metadata that groups nodes based on type;
generating an output of a generative artificial intelligence (AI); and
generating, based on a template, a document that includes the output of the generative AI and describes the element properties of the data model.

2. The system of claim 1, wherein the operations further comprise:
receiving a prompt for the generative AI;
providing at least a subset of the element properties to the generative AI; and
providing the prompt to the generative AI.

3. The system of claim 1, wherein the generating of the structured representation of the metadata that groups nodes based on type comprises:
generating a first portion of the structured representation of the metadata for a first group of nodes of base data;
generating a second portion of the structured representation of the metadata for a second group of nodes of restricted data;
generating a third portion of the structured representation of the metadata for a third group of nodes of calculated data;
generating a fourth portion of the structured representation of the metadata for a fourth group of nodes of filter element data; and
generating a fifth portion of the structured representation of the metadata for a fifth group of nodes of variable element data.

4. The system of claim 1, wherein the generating of the document comprises generating the document in portable document format (PDF) or hypertext markup language (HTML).

5. The system of claim 1, wherein the operations further comprise:
based on the generated document, duplicating the data model.

6. The system of claim 1, wherein the document describes a calculated measure with exception aggregation.

7. The system of claim 1, wherein the document describes a restricted measure without constant selection.

8. The system of claim 1, wherein the document describes a restricted measure with constant selection of all dimensions.

9. The system of claim 1, wherein the document describes a restricted measure using a restricted variable.

10. The system of claim 1, wherein the document describes a count distinct measure with one or more dimensions.

11. The system of claim 1, wherein the document describes a restricted measure variable with a filter comprising one or more values.

12. The system of claim 1, wherein the document describes a restricted measure variable with a filter comprising one or more ranges.

13. A non-transitory computer-readable medium that stores instructions that, when executed by one or more processors, cause the one or more processors to perform operations comprising:
generating, based on a JavaScript Object Notation (JSON) resource that comprises metadata for element properties of a data model, a structured representation of the metadata that groups nodes based on type;
generating an output of a generative artificial intelligence (AI); and
generating, based on a template, a document that includes the output of the generative AI and describes the element properties of the data model.

14. The non-transitory computer-readable medium of claim 13, wherein the operations further comprise:
receiving a prompt for the generative AI;
providing at least a subset of the element properties to the generative AI; and
providing the prompt to the generative AI.

15. The non-transitory computer-readable medium of claim 13, wherein the generating of the structured representation of the metadata that groups nodes based on type comprises:
generating a first portion of the structured representation of the metadata for a first group of nodes of base data;
generating a second portion of the structured representation of the metadata for a second group of nodes of restricted data;
generating a third portion of the structured representation of the metadata for a third group of nodes of calculated data;
generating a fourth portion of the structured representation of the metadata for a fourth group of nodes of filter element data; and
generating a fifth portion of the structured representation of the metadata for a fifth group of nodes of variable element data.

16. The non-transitory computer-readable medium of claim 13, wherein the generating of the document comprises generating the document in portable document format (PDF) or hypertext markup language (HTML).

17. The non-transitory computer-readable medium of claim 13, wherein the operations further comprise:
based on the generated document, replicating or recreating the data model.

18. A method comprising:
generating, by one or more processors and based on a JavaScript Object Notation (JSON) resource that comprises metadata for element properties of a data model, a structured representation of the metadata that groups nodes based on type;
generating, by the one or more processors, an output of a generative artificial intelligence (AI); and
generating, by the one or more processors and based on a template, a document that includes the output of the generative AI and describes the element properties of the data model.

19. The method of claim 18, wherein the document describes a calculated measure with exception aggregation.

20. The method of claim 18, wherein the document describes a restricted measure without constant selection.
